(19) United States
(12) Patent Application Publication
(10) Pub. No.: US 2012/0290710 A1
(43) Pub. Date: Nov. 15, 2012

(54) METHOD AND APPARATUS FOR DYNAMICALLY ADJUSTING DATA STORAGE RATES IN AN APM SYSTEM

(75) Inventors: John Monk, Larkspur, CO (US); Dan Prescott, Elbert, CO (US); Robert Vogt, Colorado Springs, CO (US); Shawn McManus, Colorado Springs, CO (US)

(73) Assignee: FLUKE CORPORATION, Everett, WA (US)

(21) Appl. No.: 13/106,834

(22) Filed: May 12, 2011

(51) Int. Cl. G06F 15/173

(52) U.S. Cl. 709/224

(57) ABSTRACT

Data storage rates are dynamically adjusted in an APM system, by monitoring data storage elements and modulating the data storage when a determination is made that the storage buffer utilization is too high.

### BACKGROUND OF THE INVENTION

This invention relates to networking, and more particularly to adjusting data storage rates in an application performance management (APM) system.

Application performance management (APM) uses monitoring and/or troubleshooting tools for observation of network traffic and for application and network optimization and maintenance. The current state of the art in most application performance management systems employs multi-threaded, pipelined collections of acquisition, real time analysis and storage elements. These APM systems can only analyze data up to a finite data rate, past which point they fail to function or must fundamentally shift their operation (for example, relegating analysis in favor of storage).

In high traffic networks, data volume can lead to oversubscription, the condition where the incoming data rate is too high for network monitoring systems to process. One way this problem manifests itself is in terms of analysis latency. There is software latency in all application specific application analyzers (applications such as: Http, Oracle, Citrix, TCP, etc). When it is attempted to analyze too much data, the aggregate latency across various discrete portions of a monitoring system puts enough collective drag on the overall system that it becomes difficult to keep up with processing and analyzing the incoming data. It is computationally impractical to perform full analysis in real time of every packet/flow/conversation and store all the corresponding low level metadata on a highly utilized computer network.

Another manifestation of this problem is output latency. In some cases while analysis systems can keep up with incoming traffic from an analysis point of view, due to the volume of data that is being written to disk (transactions, packets, statistics, etc), the disk writes take long enough that “back pressure” is exerted upstream onto analysis which eventually slows down analysis to the point where the analysis can no longer keep up with incoming traffic. In a multithreaded, decoupled system the “back pressure” is the competition for CPU bandwidth between, for example, a DBMS and APM analysis software. During periods of sustained DBMS writes, the DBMS engine necessarily uses more of the total CPU “budget”, thereby leaving less CPU time for analysis.

### SUMMARY OF THE INVENTION

An object of the invention is to provide for dynamically adjusting data storage rate in an APM system, by monitoring data acquisition hardware and reducing the data storage rate when a determination is made that the data rate is too high for processing by downstream analysis processes.

Accordingly, it is another object of the present invention to provide an improved APM system that dynamically adjust the data storage rate.

It is a further object of the present invention to provide an improved network monitoring system that adjusts data storage rates dynamically to avoid analysis errors from oversubscription.

It is yet another object of the present invention to provide improved methods of network monitoring and analysis that enable dynamic adjustment of data storage rates.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a block diagram of a network with a network analysis product interfaced therewith;

FIG. 2 is a block diagram of a monitor device for dynamically adjusting data acquisition rates; and

FIG. 3 is a diagram illustrating the operation of the apparatus and method for dynamically adjusting data storage rates.

### DETAILED DESCRIPTION

The system according to a preferred embodiment of the present invention comprises a monitoring system and method and an analysis system and method for dynamically adjusting data storage rates in an APM system.

The rate of storage of data describing observed network traffic is dynamically adjusted to prevent storage overhead from negatively impacting the ability of the system to continue analyzing the network traffic. This solves the problem of the disparity between computing performance and data storage performance negatively affecting the overall analysis throughput of an application performance monitoring system.

The invention monitors the incoming network traffic rates and the rate at which the traffic is being stored and computes the amount of time that the current rate of storage can be maintained without dropping incoming packets, called time to failure (TTF). If the TTF value drops below a certain threshold, the amount of data being stored will be decreased. This process of computing the TTF value and reacting is repeated until the system reaches a stable state where the current rate of storage can be maintained indefinitely without the system dropping incoming packets. Conversely, if the system detects that it is storing data under its maximum capacity and not all of the desired data is being stored, the system will increase the rate of storage reassess the stability of the system.

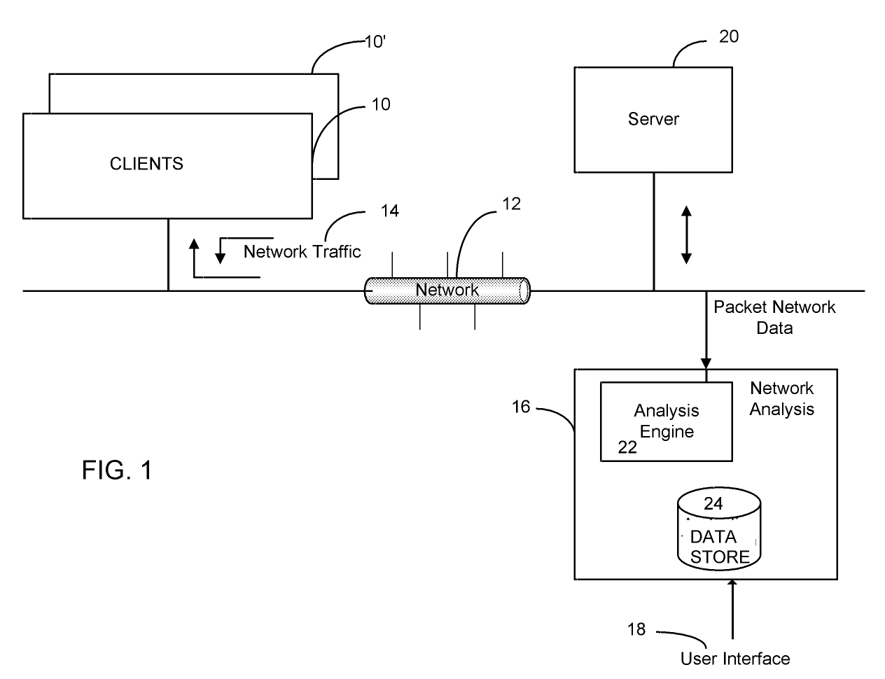

Referring to FIG. 1, a block diagram of a network with an apparatus in accordance with the disclosure herein, a network may comprise plural network clients 10, 10′, etc., which communicate over a network 12 by sending and receiving network traffic 14 via interaction with server 20. The traffic may be sent in packet form, with varying protocols and formatting thereof.

A network analysis device 16 is also connected to the network, and may include a user interface 18 that enables a user to interact with the network analysis device to operate the analysis device and obtain data therefrom, whether at the location of installation or remotely from the physical location of the analysis product network attachment.

The network analysis device comprises hardware and software, CPU, memory, interfaces and the like to operate to connect to and monitor traffic on the network, as well as performing various testing and measurement operations, transmitting and receiving data and the like. When remote, the network analysis device typically is operated by running on a computer or workstation interfaced with the network. One or more monitoring devices may be operating at various locations on the network, providing measurement data at the various locations, which may be forwarded and/or stored for analysis.

The analysis device comprises an analysis engine 22 which receives the packet network data and interfaces with data store 24.

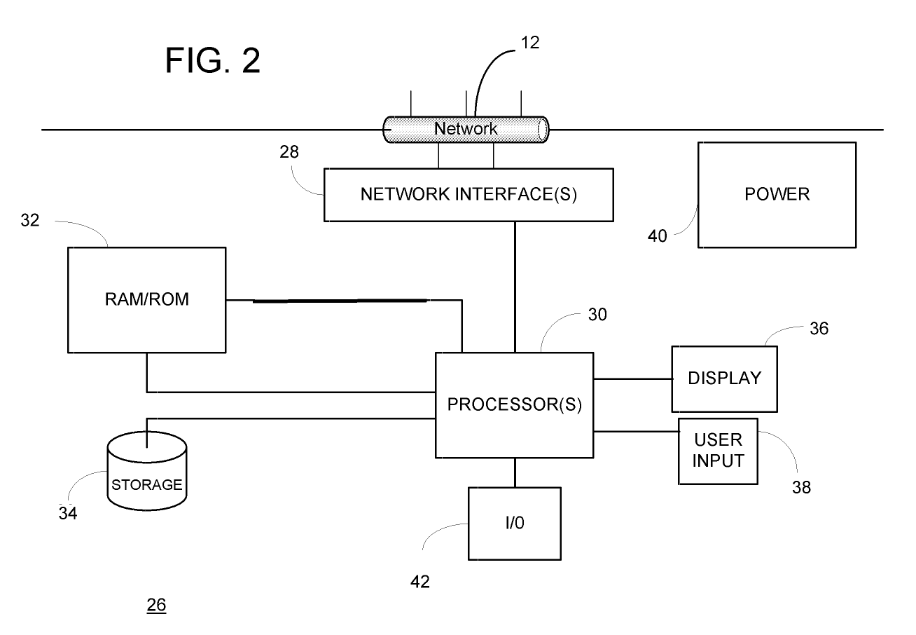

FIG. 2 is a block diagram of a test instrument/analyzer 26 via which the invention can be implemented, wherein the instrument may include network interfaces 28 which attach the device to a network 12 via multiple ports, one or more processors 30 for operating the instrument, memory such as RAM/ROM 32 or persistent storage 34, display 36, user input devices (such as, for example, keyboard, mouse or other pointing devices, touch screen, etc.), power supply 40 which may include battery or AC power supplies, other interface 42 which attaches the device to a network or other external devices (storage, other computer, etc.).

In operation, the network test instrument is attached to the network, and observes transmissions on the network to collect data and analyze and produce statistics and metadata thereon. In a particular embodiment, the instrument monitors the storage buffer utilization, to determine whether or not storage processes are able to keep up with the rate at which data is scheduled to be written.

To scale back the amount of data that is stored, tracking is made of the backlog of data that is scheduled to be written to disk and then it is decided whether or not to actually write the data. Each individual object that can write data to storage and that is to be monitored has a buffer of data to be written. Each one of these objects keeps track of how full this buffer is at any point in time. This storage utilization information is aggregated by the a performance manager which then passes this information to a downstream software agent (the storage attenuator) that decides whether or not to write/exclude more data as appropriate. This decision is passed back to the individual data writer threads.

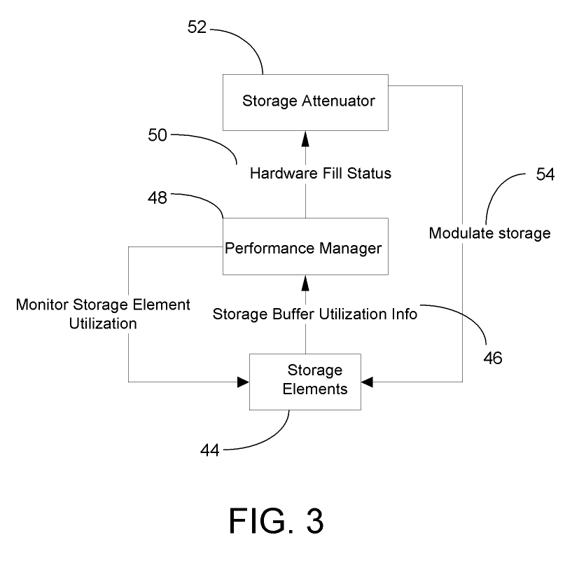

Referring to FIG. 3, a diagram of the operation of the apparatus and method for dynamically adjusting data storage rates, storage elements 44 to which data is being stored (for example, disk drives or other mass storage) provide storage buffer utilization information 46 to a performance manager 48, which monitors the storage buffer utilization, and supplies an aggregate storage buffer fill status 50 to storage attenuator 52. The storage attenuator passes attenuation information 54 to the storage elements to control storage operations based on an attenuation schedule.

In operation, to scale back the amount of data that is stored, the backlog of data that is scheduled to be written to disk is used to decide whether or not to actually write the data. The modulate storage decision 54 from the storage attenuator governs whether to write/exclude more data as appropriate.

In order to scale back the data that is stored, the incoming data is sampled at the “conversation” level, rather than the flow or packet level. The conversation level means, for example, a series of data exchanges between two IP addresses with a given protocol type. Since some data is excluded from detailed storage when scaling takes place, in order to maintain some meaning to the stored data in later analysis, flows/packets that are excluded from storage are accounted for by determining packet count/byte count characteristics of the particular metrics that is of interest (for example, transactions) with respect to a given criteria (for example, application (as defined by port), IP addresses), using the flows that get stored and ultimately analyzed as the source of empirical observations. Then the desired metric is inferred using the counts of the excluded traffic. While this results in some limitations on the data analysis, such as reduced accuracy, or limitation on flexibility of sorting criteria, this approach does allow determination of transient phenomena, such as spikes in traffic.

The modulation of storage may be accomplished by reference to attenuation schedules, multiple such schedules being possible. In a particular embodiment, a general attenuation schedule is provided for normal operation and an aggressive attenuation schedule is provided for situations where the hardware monitoring determines that the general attenuation schedule is not sufficient resolve the storage backlog. The schedules provide a percentage value of conversations that are to be attenuated, whereby the conversations that are attenuated are not passed on for storage.

Example attenuation schedules are:

General attenuation schedule

| | attenuate this % of |
|---|---|
| hardware fill ‘level’ | conversations |
| 0% | attenuation = 0 |
| 10% | attenuation = 0 |
| 20% | attenuation = 0 |
| 30% | attenuation = 20 |
| 40% | attenuation = 30 |
| 50% | attenuation = 40 |
| 60% | attenuation = 50 |
| 70% | attenuation = 60 |
| 80% | attenuation = 70 |
| 90% | attenuation = 80 |
| 100% | attenuation = 80 |

Aggressive attenuation schedule

| | attenuate this % of |
|---|---|
| hardware fill ‘level’ | conversations |
| 0% | attenuation = 0 |
| 10% | attenuation = 0 |
| 20% | attenuation = 20 |
| 30% | attenuation = 30 |
| 40% | attenuation = 40 |
| 50% | attenuation = 50 |
| 60% | attenuation = 60 |
| 70% | attenuation = 70 |
| 80% | attenuation = 80 |
| 90% | attenuation = 90 |
| 100% | attenuation = 90 |

Accordingly, the invention accordingly provides dynamic adjustment of data storage rates in an APM system, to avoid oversubscription, while still providing data storage for downstream analysis and inference based on discarded data. The system, method and apparatus dynamically adjust the rate of network data storage when the data rates present exceed the capacity of the system storage elements to store them, solving the problem of allowing excessive network data storage backlog to overwhelm an application performance monitoring system.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method of dynamically adjusting a data storage rate for an application performance management system, comprising:
monitoring a data storage element utilization; and
attenuating conversations stored based on the monitored utilization.

2. The method according to claim 1, wherein said attenuating comprises:
employing an attenuation schedule to determine when conversations should be stored or not stored.

3. The method according to claim 1, wherein said attenuating comprises:
employing plural attenuation schedules to determine when conversations should be stored or not stored, said schedules chosen based on the monitored utilization.

4. A system for dynamically adjusting a data storage rate for an application performance management system, comprising:
a data storage buffer utilization monitor; and
a storage attenuator receiving a utilization rate value from said monitor, said attenuator attenuating conversations provided for downstream storage based on the monitored utilization.

5. The system according to claim 4, wherein said storage attenuator comprises:
an attenuation schedule to determine when conversations should be stored or not stored.

6. The system according to claim 4, wherein said storage attenuator comprises:
plural attenuation schedules to determine when conversations should be stored or not stored, said schedules chosen based on the utilization.

7. A network test instrument for dynamically adjusting a data storage rate for an application performance management system, comprising:
network data acquisition device including data storage;
a data storage utilization monitor; and
a storage attenuator receiving a utilization status value from said monitor, said attenuator attenuating conversations provided for storage based on the monitored utilization status.

8. The network test instrument according to claim 7, wherein said storage attenuator comprises:
an attenuation schedule to determine when conversations should be stored or not stored.

9. The network test instrument according to claim 7, wherein said storage attenuator comprises:
plural attenuation schedules to determine when conversations should be stored or not stored, said schedules chosen based on the monitored utilization status.
